(19) United States
(12) Patent Application Publication
(10) Pub. No.: US 2021/0283007 A1
(43) Pub. Date: Sep. 16, 2021

(54) Boot For Therapeutic Vibrational Device such as Tuning Fork

(71) Applicants: Todd L Gardner, Batavia, IL (US); Eileen Day McKusick, Winooski, VT (US)

(72) Inventors: Todd L Gardner, Batavia, IL (US); Eileen Day McKusick, Winooski, VT (US)

(21) Appl. No.: 16/816,013

(22) Filed: Mar. 11, 2020

(51) Int. Cl. A61H 23/00

(52) U.S. Cl. CPC A61H 23/004; A61H 2201/0107; A61H 2201/169; A61H 2201/1645

(57) ABSTRACT

A therapeutic vibration device includes a vibration generator, such as a tuning fork having an end, and a head or “boot” attached to the end of the generator and having a dimpled surface. The dimpled surface is sized and shaped to contact a patient to transmit vibrations to the patient for therapeutic benefits during treatment. The dimpled surface can be substantially spherically contoured and substantially smooth with dimples. The dimpled surface can have a dome or other convex shape.

### BACKGROUND

A recent study has shown that mechanical stimulation can repair muscle. McAlpine, Kat J. “Wyss and SEAS teams find new strength in regenerative medicine,” Harvard Gazette, Jan. 26, 2016, reporting on a study by Wyss Institute for Biologically inspired Engineering at Harvard University, and Harvard John A. Paulson School of Engineering and Applied Silences (SEAS).

Tuning forks for applying vibration to a patient for therapeutic treatment and massage are known. U.S. Pat. No. 7,381,193 discloses smooth crowned heads for patient contact. U.S. Pat. No. 8,282,586 and US Patent Application 2017/0348185 disclose tuning fork therapeutic devices having heads of various shapes.

The present inventors have recognized that heretofore known vibrational therapy devices could be improved, particularly the portion of the device that contacts the patient's skin.

### SUMMARY

The exemplary embodiment of the present invention provides an improved boot for a therapeutic vibration device such as a tuning fork and an improved tuning fork.

The therapeutic vibration device applies vibration to a patient, and includes a vibration generator having an end, and a head or “boot” attached to the end of the generator and having a dimpled surface. The dimpled surface is sized and shaped to contact a patient to transmit vibrations to the patient for therapeutic benefits during treatment. The dimpled surface can be substantially spherically contoured. The dimpled surface can have a dome or other convex shape.

For a therapeutic tuning fork, the boot can be attached to the end of the tuning fork and has an irregular surface sized and shaped to contact a patient to transmit vibrations to the patient for therapeutic benefits. The irregular surface can be a dimpled surface. The dimpled surface can be a substantially smooth surface having dimples. The dimpled surface can be substantially spherically contoured. The dimpled surface can have a dome or other convex shape.

The exemplary embodiment of the present invention provides an improved boot that can be used with a tuning fork or other vibrating therapeutic device. The boot can have an irregular surface sized and shaped to contact a patient to transmit vibrations to the patient for therapeutic benefits. The irregular surface can be a dimpled surface. The dimpled surface can be a substantially smooth surface having dimples. The dimpled surface can be substantially spherically contoured. The dimpled surface can have a dome or other convex shape.

For a boot having a dimpled surface, the dimpled surface may trap soundwaves and keep them bouncing between the boot and the body. This increased resonance may give the boot the property of both locating areas that are sluggish and underpowered electrically in the body, and then delivering pulsed mechanical stimulation to the muscle.

In comparison, a smooth surface which lies over the surface of tissue may not achieve the same kind of identification and focused resonance that the dimpled surface provides.

When combined with a tuning fork, this simple apparatus can deliver immediate relief to sore muscles and may speed healing. Muscle tone may be improved through regular application of vibration through this technique. Muscle tension may be reduced and muscle strength may be increased.

A study (Wyss Institute for Biologically Inspired Engineering at Harvard University, and Harvard John A. Paulson School of Engineering and Applied Silences (SEAS), January 2016 cited above) has demonstrated that mechanical stimulation of muscles causes them to heal 2½ times faster than no stimulation at all. The dimpled design and trapped soundwaves may create a greater degree of stimulation of tissues that a smooth surface. Additionally, the resonant relationship between the dimples and the skin may make the device attracted to areas that are energy deficient and slow down and even stop of its own accord slid over the surface of the skin, due to the magnetic attraction between the energy of the tissues and the energy being produced by the vibrating boot.

Numerous other advantages and features of the present invention will be become readily apparent from the following detailed description of the invention and the embodiments thereof, and from the accompanying drawings.

### BRIEF DESCRIPTION OF THE DRAWINGS

FIG. 1 is an elevation view of an exemplary embodiment tuning fork treatment apparatus of the invention;

FIG. 2 is an exploded elevation view of the apparatus of FIG. 1;

FIG. 3 is an elevation view of a portion of the apparatus of FIG. 1;

FIG. 4 is a bottom view of the portion shown in FIG. 2; and

FIG. 5 is a top view of the portion shown in FIG. 3.

### DETAILED DESCRIPTION

While this invention is susceptible of embodiment in many different forms, there are shown in the drawings, and will be described herein in detail, specific embodiments thereof with the understanding that the present disclosure is to be considered as an exemplification of the principles of the invention and is not intended to limit the invention to the specific embodiments illustrated.

U.S. Pat. Nos. 7,381,193; 8,282,586 and US Patent Application 2017/0348185 are all herein incorporated by reference to the extent that they are not contrary to the present disclosure.

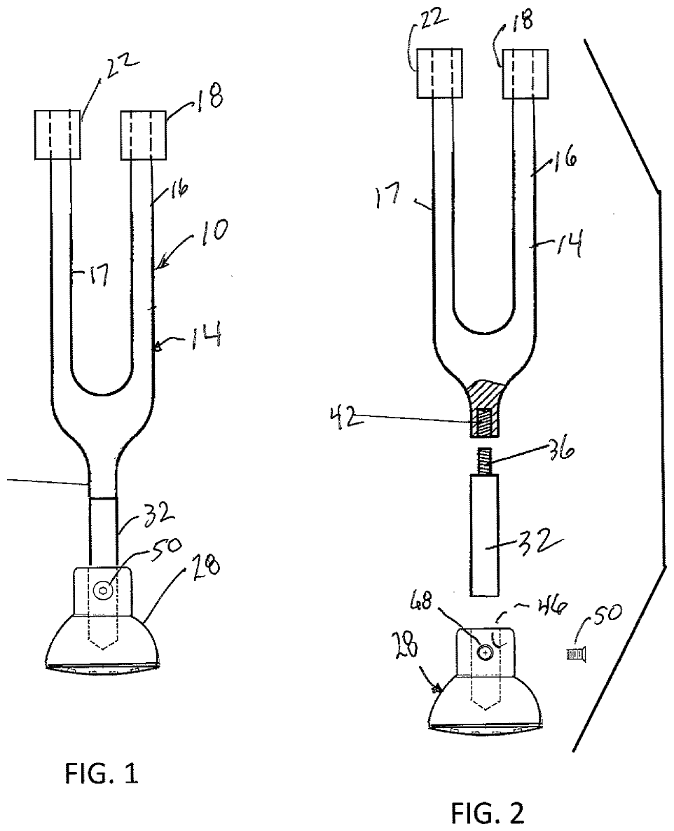

FIGS. 1 and 2 illustrate a therapeutic vibration apparatus 10. The apparatus can be an assembly as shown or of a single piece. The apparatus 10 includes a tuning fork 14 having end weights 18, 20 and an attached boot 28. FIG. 2 shows the apparatus to be an assembly including an extension bar 32. The extension bar includes a threaded spindle 36 that threads into a threaded bare 42 in the tuning fork 14. Alternatively, the extension can be formed in unitary fashion with the tuning fork 14 and/or the boot 28. The opposite end of the extension 32 fits into a plain bore 46 in the boot and is fixed there by a set screw 50. Alternately to the set screw, the extension can be fixed to the boot by being threaded into the boot, the extension having male threads and the bore 46 having female threads. Alternately to the set screw, the extension can be fixed to the boot by insertion into the bore 46 with epoxy or adhesive applied between the extension and the bore 46. The boot and the extension can be welded, brazed or other known technique of attachment.

The weights 18, 22 can be cylindrically shaped having slots 18a, 22a for receiving tines 16, 17 of the tuning fork 14. Some applications of the apparatus 10 eliminate weights on the tines 16, 17. The weights, when used, can be permanently attached to the tines 16, 17. The weights can be adjustable on the tines to adjust the resonant frequency of the fork 14. The weights can be selected or adjusted to adjust the resonant frequency of the fork depending on the treatment and/or treatment area of the patient.

The extension 32 provides room for the treating professional's hand to manipulate the apparatus during treatment.

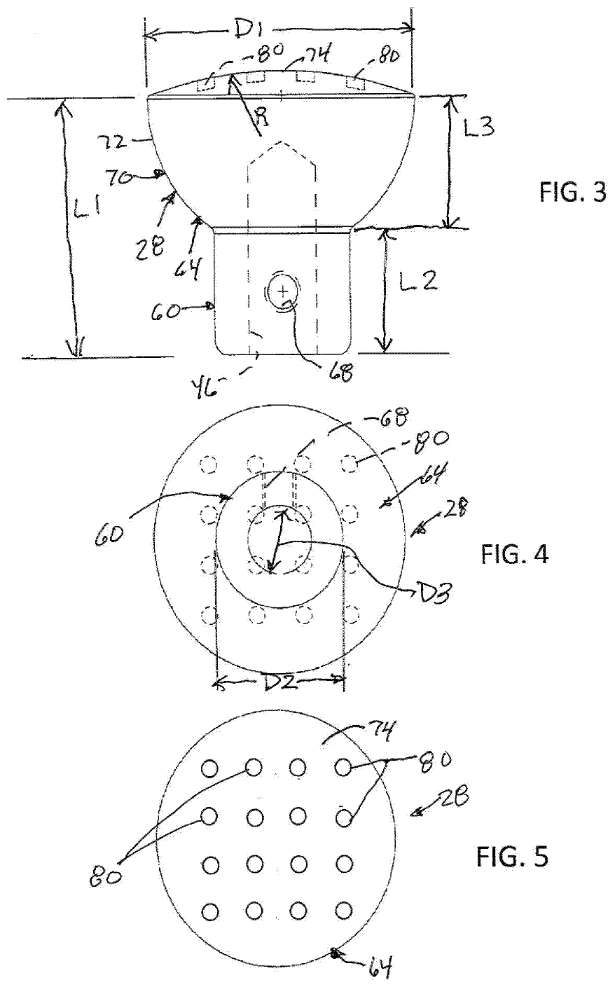

FIGS. 3-5 illustrates the boot 28 in more detail. The boot 28 includes a base portion 60 and a head portion 64. The portions 60, 64 may be formed as one piece or connected together. The base portion 60 is cylindrically shaped, providing for the plain bore 46 passing therethrough. The plain bore 46 also extends into the head portion 64. The base portion 60 includes a threaded bore 68 for receiving the set screw 50 and fixing the extension 32 to the boot 28.

The head portion 64 includes a parabolically contoured body 70 with an outside body surface 72 ending in a substantially spherically contoured end surface 74. Both the outside body surface 72 and the end surface 74 are convex outside surfaces. Although a convex end surface 74 is shown and described, a flat or concave end surface is also encompassed by the invention. The end surface 74 can be substantially smooth surface with spaced irregularities, such as blind holes or “dimples” 80. The dimples 80 are shown spaced apart in a grid pattern with 16 dimples 80.

The boot 28 can have the following exemplary dimensions, although other dimensions are encompassed by the invention: The diameter of the boot D1 can be within a range of between ½ and 3 inches, advantageously about 1.2 inches. The length L1 of the boot 28 to the edge of the end surface 74 can be about 1.1 inches. The length L2 of the base portion 60 can be about 0.5 inches. The length L3 of the body portion 64 can be about 0.5 inches. The radius R of the spherically contoured end surface 74 can be within a range of between ½ and 4 inches, advantageously about 2 inches. The diameter D2 of the base portion 60 can be about 0.6 inches. The bore 46 can have a diameter D3 of about 0.3 inches.

The dimples 80 can have a diameter within a range between 0.05 to 0.4 inches, and advantageously about 0.08 inches, inches and can have a depth within a range between 0.03 to 0.4 inches, and advantageously about 0.05 inches. Although 16 dimples shown in FIGS. 4 and 5 is advantageous, other numbers of dimples could also be used. An exemplary number of dimples 80 can be within a range of 3-60 dimples, and more advantageously between 4-36 dimples.

Exemplary composition of the components are:

Boot: stainless steel, aluminum, quartz, glass, stone, plastic or other suitable material.

Tuning fork: aluminum or steel or other suitable material.

Extension: aluminum or steel or other suitable material.

Weights: aluminum or steel or other suitable material.

From the foregoing, it will be observed that numerous variations and modifications may be incorporated without departing from the spirit and scope of the invention. It is to be understood that no limitation with respect to the specific apparatus illustrated herein is intended or should be inferred.

The invention claimed is:

1. A therapeutic vibration device for applying vibration to a patient, comprising:
a vibration generator having an end; and
a boot attached to the end of the generator and having a dimpled surface sized and shaped to contact a patient to transmit vibrations to the patient for therapeutic benefits.

2. The device according to claim 1, wherein the dimpled surface is spherically contoured.

3. The device according to claim 1, wherein the dimpled surface has a dome shape.

4. The device according to claim 1, wherein the dimpled surface has a convex shape.

5. A therapeutic vibration device for applying vibration to a patient, comprising:
a tuning fork having an end: and
a boot attached to the end of the tuning fork and having an irregular surface sized and shaped to contact a patient to transmit vibrations to the patient for therapeutic benefits.

6. The device according to claim 5, wherein the irregular surface comprises a dimpled surface.

7. The device according to claim 5, wherein the dimpled surface comprises a smooth surface having dimples.

8. The device according to claim 5, wherein the dimpled surface is spherically contoured.

9. For a boot for a therapeutic vibration device for applying vibration to a patient, the improvement comprising:
the boot having an irregular surface sized and shaped to contact a patient to transmit vibrations to the patient for therapeutic benefits.

10. The improvement according to claim 9, wherein the irregular surface comprises a dimpled surface.

11. The improvement according to claim 9, wherein the dimpled surface comprises a smooth surface having dimples.

12. The improvement according to claim 9, wherein the dimpled surface is spherical.
